(19) United States
(12) Patent Application Publication
(10) Pub. No.: US 2026/0205659 A1
(43) Pub. Date: Jul. 16, 2026

(54) SYSTEMS AND METHODS FOR VARIABLE-SPEED MEDIA PLAYBACK

(71) Applicant: Netflix, Inc., Los Gatos, CA (US)

(72) Inventors: Weiguo Zheng, San Jose, CA (US); Michael Schassberger, San Ramon, CA (US)

(21) Appl. No.: 19/387,233

(22) Filed: Nov. 12, 2025

Related U.S. Application Data
(60) Provisional application No. 63/720,285, filed on Nov. 14, 2024.

(51) Int. Cl. H04N 21/462; H04N 21/439; H04N 21/44

(52) U.S. Cl. CPC H04N 21/462; H04N 21/4394; H04N 21/44008

(57) ABSTRACT

The disclosed computer-implemented method may include detecting, by a computing device, a media stream from a source device to the computing device. Additionally, the method may include extracting, by the computing device, a segment of the media stream and metadata for the segment of the media stream from a streaming buffer. The method may also include classifying, by the computing device, a level of activity within frames of the segment by a trained model using the metadata of the segment. Furthermore, the method may include performing, by the computing device, an adjustment of at least one frame of the segment based on the classification by the trained model. Various other methods, systems, and computer-readable media are also disclosed.

### CROSS REFERENCE TO RELATED APPLICATION

This application claims the benefit of U.S. Provisional Application No. 63/720,285, filed 14 Nov. 2024, the disclosure of which is incorporated, in its entirety, by this reference.

### BACKGROUND

In the streaming and playback of live digital media content, clock jitter and variability in network conditions (e.g., congestion and burstiness) can result in playback inconsistencies, leading to buffer overflow or underflow. For example, slight differences in clock speeds can accumulate over time and lead to deviations in the expected arrival or playback timing of media frames. Data that is processed faster than it is received leads to buffer underflow while data that is processed slower than it arrives leads to buffer overflow. Additionally, particularly for livestreaming media, network congestion due to a high volume of data traffic can create variability in the delivery of media packets and can affect streaming performance. These issues can then lead to visible playback issues, such as stuttering, skipping, freezing, or delayed output.

Traditionally, addressing these issues can require complex decoding processes or additional computational overhead, which negatively impacts performance and increases latency. For example, traditional methods often increase memory size for the streaming buffer to avoid buffer overflow. Traditional methods that require the media to be decoded, such as by transforming audio and video streams from a compressed format into an uncompressed format, involve considerable computational effort. Different platforms may also implement variable speed playback in distinct ways, leading to variability in playback quality and inconsistent behaviors across systems. This variability introduces significant challenges, including increased testing efforts and higher maintenance costs. Furthermore, live media playback is especially sensitive to timeliness, and methods that take longer to process can create noticeable delays. Thus, better methods of adjusting media playback speed are needed to provide generalizable techniques that subtly enable variable speeds without disrupting user experience.

### SUMMARY

As will be described in greater detail below, the present disclosure describes systems and methods for variable-speed media playback. In one example, a computer-implemented method for variable-speed media playback includes detecting, by a computing device, a media stream from a source device to the computing device. The method also includes extracting, by the computing device, a segment of the media stream and metadata for the segment of the media stream from a streaming buffer. In addition, the method includes classifying, by the computing device, a level of activity within frames of the segment by a trained model using the metadata of the segment. Furthermore, the method includes performing, by the computing device, an adjustment of at least one frame of the segment based on the classification by the trained model.

In one embodiment, the segment of the media stream includes a predetermined length based on a size of the streaming buffer.

In one example, extracting the metadata for the segment of the media stream includes determining a compression gain of at least one audio frame of the segment and/or determining a compressed frame size of at least one video frame of the segment. In this example, the trained model includes a Hidden Markov Model (HMM) trained to classify the level of activity within audio frames by characterizing an energy of at least one audio frame of the segment using the compression gain and classify the level of activity within video frames by characterizing a motion corresponding to at least one video frame of the segment using the compressed frame size. In this example, classifying the level of activity within an audio frame of the audio frames of the segment includes comparing the energy of the audio frame with other audio frames over time and, based on the comparison, classifying the audio frame as active or silent. Additionally, in this example, classifying the level of activity within a video frame of the segment includes comparing the motion corresponding to the video frame with other video frames over time and, based on the comparison, classifying the video frame as high-motion or low-motion.

In some embodiments, performing the adjustment includes performing the adjustment of a silent frame and/or a low-motion frame. In some embodiments, performing the adjustment includes repeating the silent frame or the low-motion frame based on a minimum buffer threshold and/or skipping the silent frame or the low-motion frame based on a maximum buffer threshold.

In some examples, performing the adjustment includes adjusting an audio timestamp of the segment, adjusting a video timestamp of the segment, and/or aligning the audio timestamp of the segment with the video timestamp of the segment within a predetermined threshold.

In addition, a corresponding system for variable-speed media playback includes several modules stored in memory, including a detection module that detects, by a computing device, a media stream from a source device to the computing device. The system also includes an extraction module that extracts, by the computing device, a segment of the media stream and metadata for the segment of the media stream from a streaming buffer. In addition, the system includes a classification module that classifies, by the computing device, a level of activity within frames of the segment by a trained model using the metadata of the segment. Furthermore, the system includes a performance module that performs, by the computing device, an adjustment of at least one frame of the segment based on the classification by the trained model. Finally, the system includes one or more processors that execute the detection module, the extraction module, the classification module, and the performance module.

In one embodiment, the segment of the media stream includes a predetermined length based on a size of the streaming buffer. In this embodiment, the extraction module extracts the metadata for the segment of the media stream by determining a compression gain of at least one audio frame of the segment and/or determining a compressed frame size of at least one video frame of the segment. In this embodiment, the trained model includes an HMM trained to classify the level of activity within audio frames by characterizing an energy of at least one audio frame of the segment using the compression gain and classify the level of activity within video frames by characterizing a motion corresponding to at least one video frame of the segment using the compressed frame size. In this embodiment, the classification module classifies the level of activity within an audio frame of the audio frames of the segment by comparing the energy of the audio frame with other audio frames over time and, based on the comparison, classifying the audio frame as active or silent. Additionally, in the above embodiment, the classification module classifies the level of activity within a video frame of the segment by comparing the motion corresponding to the video frame with other video frames over time and, based on the comparison, classifying the video frame as high-motion or low-motion.

In one example, the performance module performs the adjustment by performing the adjustment of a silent frame and/or a low-motion frame. In this example, the performance module performs the adjustment by repeating the silent frame or the low-motion frame based on a minimum buffer threshold and/or skipping the silent frame or the low-motion frame based on a maximum buffer threshold.

In some embodiments, the performance module performs the adjustment by adjusting an audio timestamp of the segment, adjusting a video timestamp of the segment, and/or aligning the audio timestamp of the segment with the video timestamp of the segment within a predetermined threshold.

In some examples, the above-described method may be encoded as computer-readable instructions on a non-transitory computer-readable medium. For example, a computer-readable medium may include one or more computer-executable instructions that, when executed by at least one processor of a computing device, such as a server, may cause the computing device to detect, by the computing device, a media stream from a source device to the computing device. The instructions may also cause the computing device to extract, by the computing device, a segment of the media stream and metadata for the segment of the media stream from a streaming buffer. In addition, the instructions may cause the computing device to classify, by the computing device, a level of activity within frames of the segment by a trained model using the metadata of the segment. Furthermore, the instructions may cause the computing device to perform, by the computing device, an adjustment of at least one frame of the segment based on the classification by the trained model.

In one embodiment, the computer-executable instructions may cause the computing device to extract the metadata for the segment of the media stream by determining a compression gain of at least one audio frame of the segment and/or by determining a compressed frame size of at least one video frame of the segment.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for variable-speed media playback.

FIG. 2 is a block diagram of an exemplary computing system for variable-speed media playback.

FIG. 3 is a block diagram of an exemplary series of compression gains extracted from an exemplary waveform of audio frames.

FIG. 4 is a block diagram of an exemplary trained model classifying exemplary frames of media.

FIG. 5 is an illustration of exemplary frame adjustments to speed up or slow down an exemplary set of frames.

FIG. 6 is an illustration of an exemplary frame adjustment to match a target frame rate.

FIG. 7 is a block diagram of an exemplary content distribution ecosystem.

FIG. 8 is a block diagram of an exemplary distribution infrastructure within the content distribution ecosystem shown in FIG. 7.

FIG. 9 is a block diagram of an exemplary content player within the content distribution ecosystem shown in FIG. 7.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

This application is generally directed to variable-speed media playback for livestreaming videos. As will be explained in greater detail below, streaming video and audio over the internet often creates challenges, such as delays, stuttering, or freezing. These challenges arise due to variations in the speed of computers and networks, which can lead to either buffer underflow or buffer overflow from receiving inconsistent amounts of data at a time. Previous approaches have attempted to address these issues by increasing the buffer size or employing complex methods to decode and process the media, which can result in slower performance and a diminished viewing experience. Additionally, these traditional solutions can function differently across various devices or platforms, complicating efforts to maintain smooth and consistent playback.

In contrast, the approaches described herein address these challenges by creating a more intelligent and efficient method to adjust playback speed without requiring complete decoding of the audio and video streams. Instead, the approaches utilize straightforward metadata, such as a level of sound compression or the size of a video frame, that is already embedded within each audio and video frame. Specifically, these approaches train a Hidden Markov Model (HMM) to efficiently classify audio and video frames. For example, the approaches described herein can train the model to detect quiet moments within the audio stream and low-movement moments within the video stream. In this example, the approaches can mark the timestamps of those moments as preferred times to repeat or skip frames without very noticeable differences. In some examples, the approaches described herein compensate for buffer underflow by slightly reducing playback speed through repeating silent or low-motion frames and compensate for buffer overflow by skipping silent or low-motion frames. These approaches can also ensure synchronicity between video frames and audio frames by repeating or removing frames until the video and audio timestamps are within an acceptable range of each other. Thus, the approaches described herein enable controlled playback adjustment without a viewer noticing significant errors. By dynamically adjusting playback rates to synchronize media streams with source clocks and adapting to variations in data availability, these approaches address both clock jitter and network congestion issues. Furthermore, the described approaches preserve the integrity of both audio and video streams. By quickly and efficiently identifying frames to repeat or remove, these approaches can accurately adjust media playback speed in real time.

The systems and methods described herein improve the functioning of a computing device by reducing computational overhead, e.g., by eliminating the need for decoding audio and video while streaming and by ensuring the timeliness of delivery of the streaming media. The approaches described herein accomplish this by enabling efficient media playback capable of adjusting speeds dynamically. For example, by focusing on low-energy or slow-motion segments for playback speed adjustments, the disclosed systems and methods enable speed changes without noticeable audio artifacts or visual stuttering. By utilizing metadata associated with audio and video data, the disclosed systems and methods also enable cross-platform consistency regardless of platforms or media players. In addition, these systems and methods improve the fields of media streaming and network management by ensuring buffer data is within a set range while streaming to avoid buffer overflow or underflow. By classifying audio and video frames using an HMM, the systems and methods described herein enable intelligent decisions about which frames to modify, resulting in minimal perceptual impact on playback quality. Thus, the disclosed systems and methods improve over traditional methods of media playback.

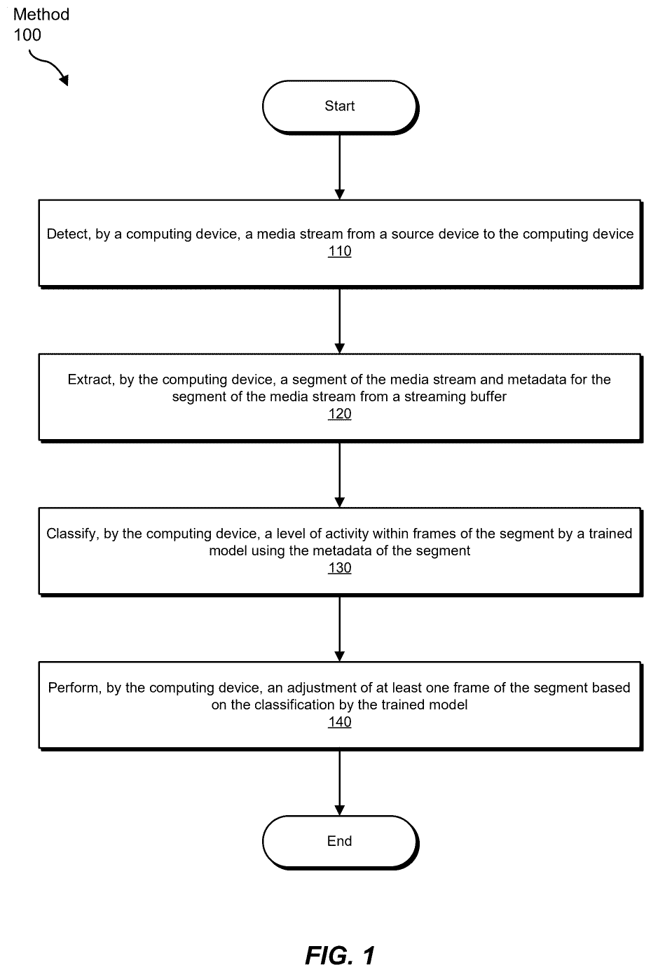

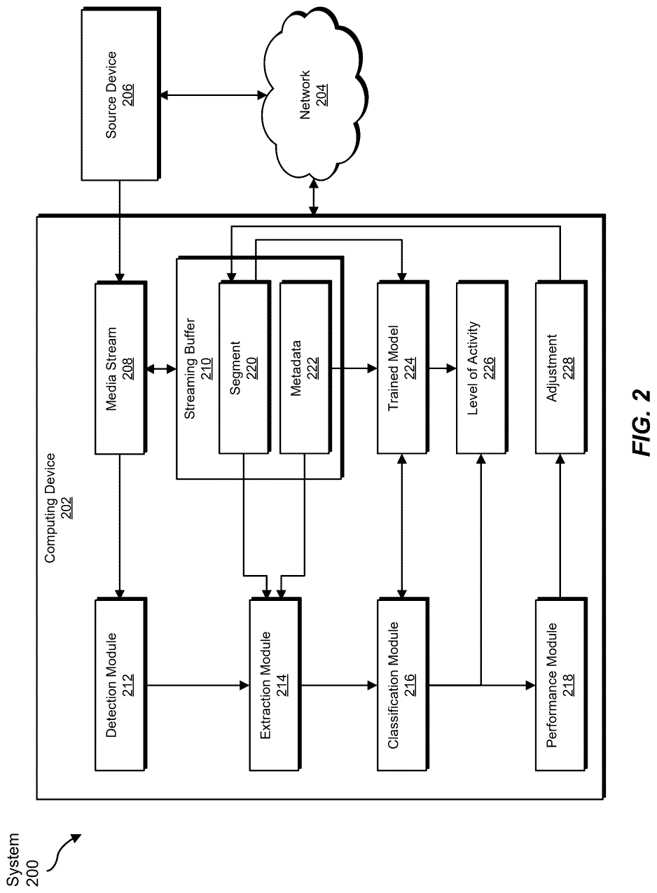

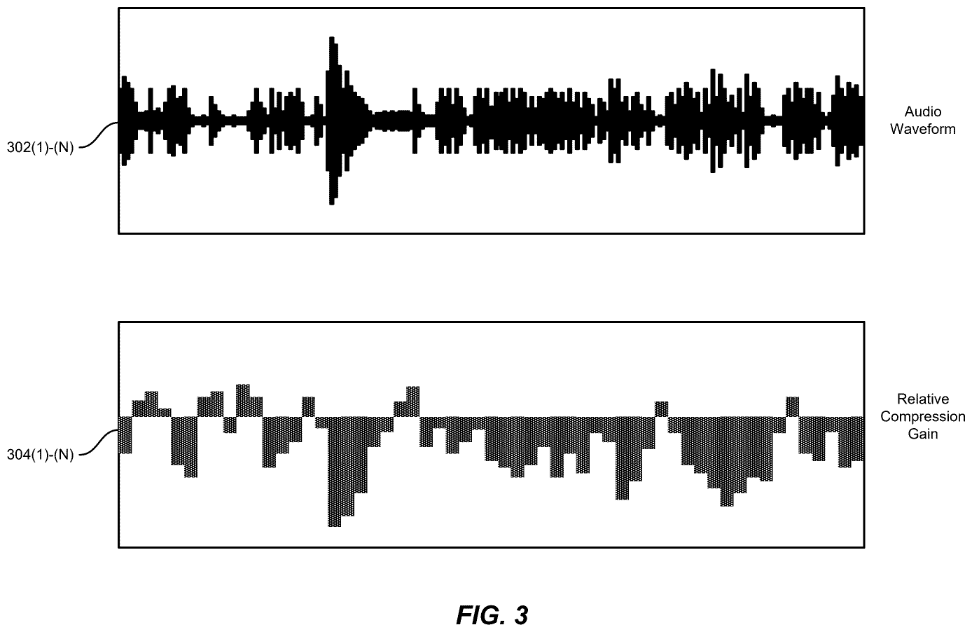

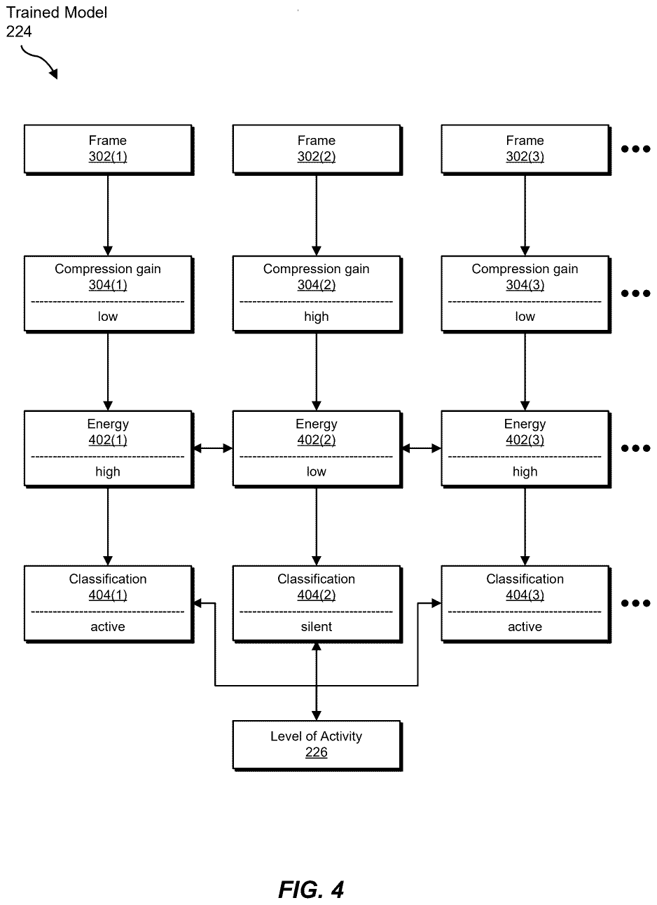

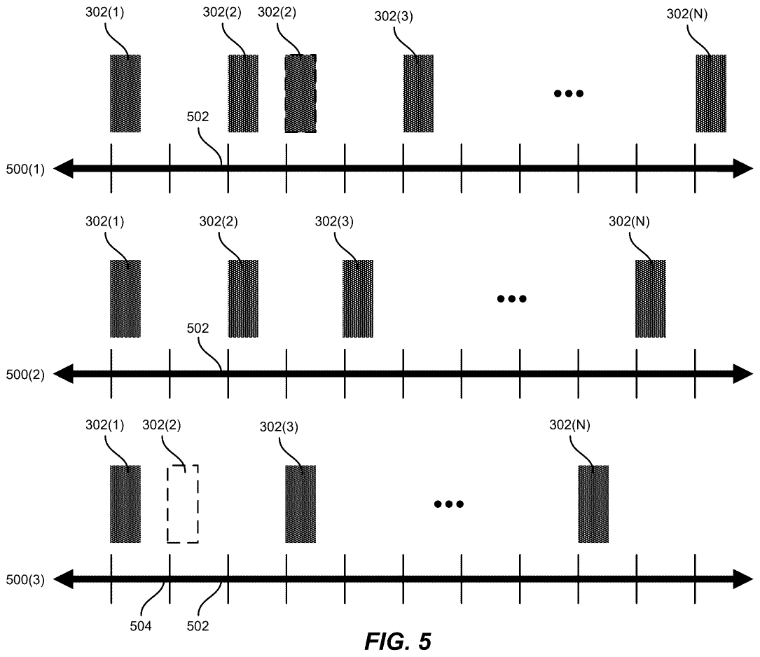

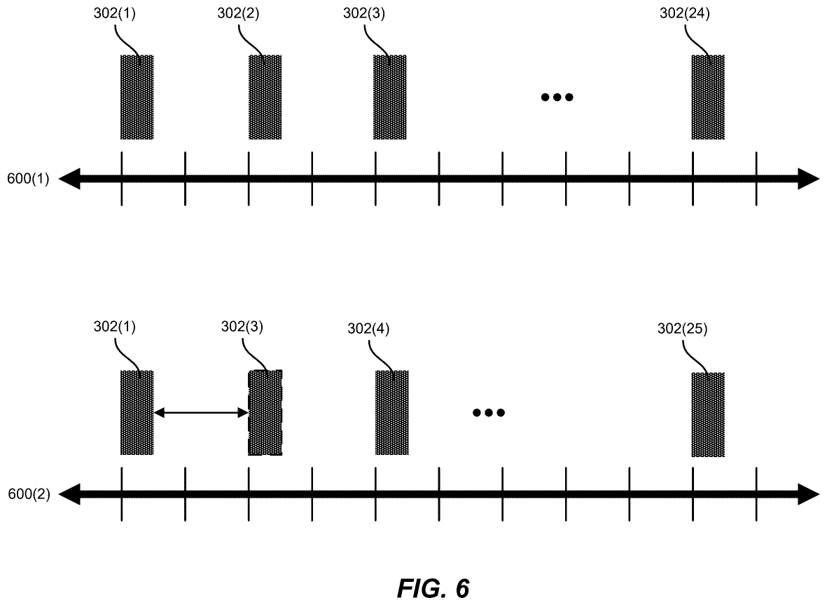

Thereafter, the description will provide, with reference to FIG. 1, detailed descriptions of computer-implemented methods for variable-speed media playback. Detailed descriptions of a corresponding exemplary computing system will be provided in connection with FIG. 2. Detailed descriptions of an exemplary series of compression gains extracted from an exemplary waveform of audio frames will be provided in connection with FIG. 3. In addition, detailed descriptions of an exemplary trained model classifying exemplary frames of media will be provided in connection with FIG. 4. Detailed descriptions of exemplary frame adjustments to speed up or slow down an exemplary set of frames will be provided in connection with FIG. 5. Furthermore, detailed descriptions of an exemplary frame adjustment to match a target frame rate will be provided in connection with FIG. 6.

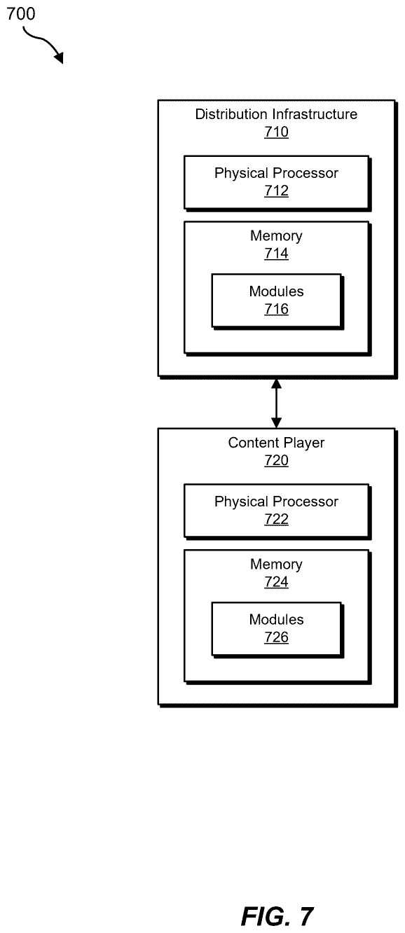

Because many of the embodiments described herein may be used with substantially any type of computing network, including distributed networks designed to provide video content to a worldwide audience, various computer network and video distribution systems will initially be described with reference to FIGS. 7-9. These figures will introduce the various networks and distribution methods used to provision video content to users.

FIG. 1 is a flow diagram of an exemplary computer-implemented method 100 for variable-speed media playback. The steps shown in FIG. 1 may be performed by any suitable computer-executable code and/or computing system, including the systems illustrated in FIGS. 7-9, computing device 202 in FIG. 2, or a combination of one or more of the same. In one example, each of the steps shown in FIG. 1 may represent an algorithm whose structure includes and/or is represented by multiple sub-steps, examples of which will be provided in greater detail below. In some examples, all of the steps and sub-steps represented in FIG. 1 may be performed by one device (e.g., either a server or a client computing device). Alternatively, the steps and/or substeps represented in FIG. 1 may be performed across multiples devices (e.g., some of steps and/or sub-steps may be performed by a server and other steps and/or sub-steps may be performed by a client computing device).

As illustrated in FIG. 1, at step 110, one or more of the systems described herein detects, by a computing device, a media stream from a source device to the computing device. For example, FIG. 2 is a block diagram of an exemplary system 200 for variable-speed media playback. As illustrated in FIG. 2, a detection module 212, as part of a computing device 202, detects a media stream 208 from a source device 206 to computing device 202.

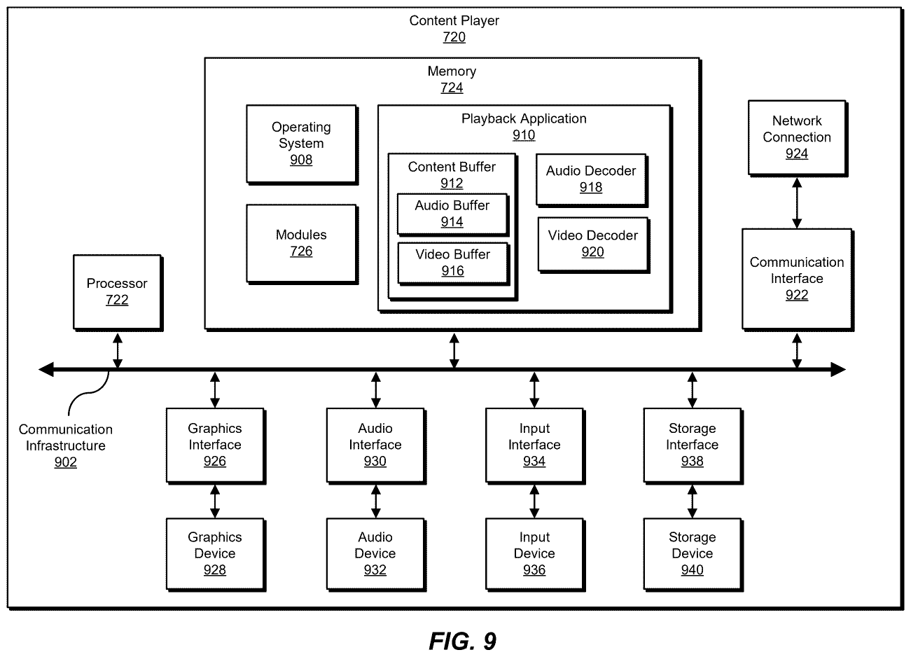

The systems described herein may perform step 110 in a variety of ways. In some embodiments, computing device 202 may generally represent any type or form of computing device capable of running computing software and applications to perform variable-speed media playback. As used herein, the term “application” generally refers to a software program designed to perform specific functions or tasks and capable of being installed, deployed, executed, and/or otherwise implemented on a computing system. Examples of applications may include, without limitation, playback application 910 of FIG. 9, productivity software, enterprise software, entertainment software, security applications, cloud-based applications, web applications, mobile applications, content access software, simulation software, integrated software, application packages, application suites, variations or combinations of one or more of the same, and/or any other suitable software application. Examples of computing devices may include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, or any other suitable computing device. Additionally, computing devices may include content player 720 in FIGS. 7 and 9 and/or various other components of FIGS. 7-9.

In some embodiments, source device 206 may generally represent a server capable of processing user and/or client device requests to perform variable-speed media playback, such as requests from computing device 202. Source device 206 may generally represent any type or form of server that is capable of storing and/or managing content and user data, such as videos for a video streaming platform. Examples of a server include, without limitation, security servers, application servers, web servers, storage servers, streaming servers, and/or database servers configured to run certain software applications and/or to provide various security, web, storage, streaming, and/or database services. Additionally, source device 206 may include distribution infrastructure 710 and/or various other components of FIGS. 7-9.

Although illustrated as part of computing device 202 in FIG. 2, some or all of the modules described herein may alternatively be executed by a separate server or any other suitable computing device. For example, computing device 202 may represent a front-end device for variable-speed media playback or, alternatively, may represent part of system 200 for backend processing of variable-speed media playback. As another example, computing device 202 may represent an endpoint device or multiple endpoint devices that service client devices. For example, system 200 may include multiple servers and/or computing devices that include source device 206, computing device 202, databases hosting a variety of data and backend services, and/or any other suitable device or combination of devices.

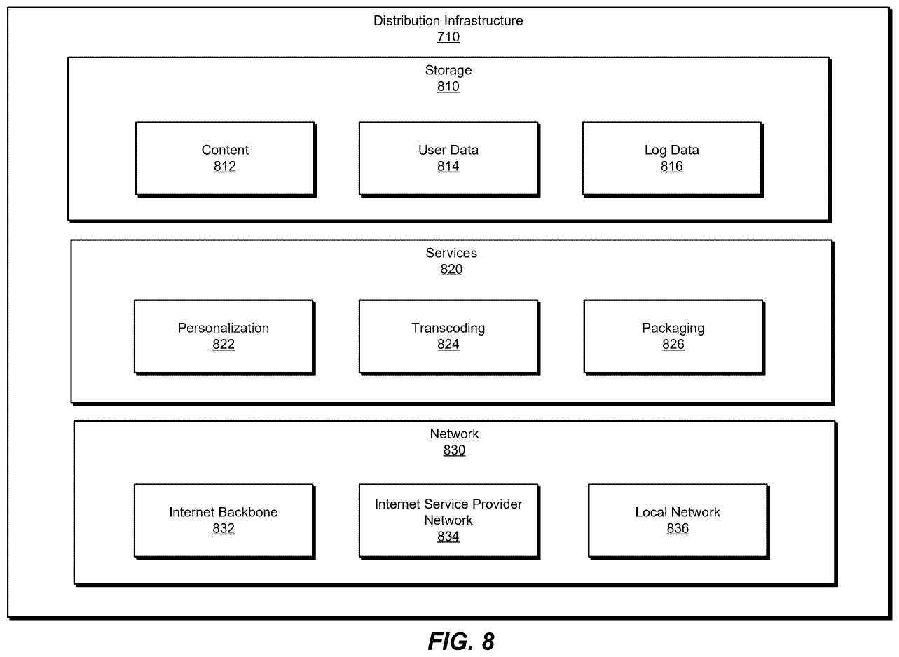

In the above embodiments, computing device 202 may be directly in communication with source device 206 and/or other servers and/or in communication with other computing devices via a network 204. In some examples, the term “network” may refer to any medium or architecture capable of facilitating communication or data transfer. Examples of networks include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), network 830 of FIG. 8, or any other suitable network. For example, a network may facilitate data transfer between computing device 202, source device 206, and/or other devices using wireless or wired connections.

In some embodiments, as shown in FIG. 2, media stream 208 passes through a streaming buffer 210 before being played by computing device 202, such as via content player 720 of FIG. 7. Although illustrated as part of computing device 202 in FIG. 2, streaming buffer 210 can represent a separate device or part of a device that receives network data before passing the data to computing device 202. In these embodiments, media stream 208 may be encoded by source device 206 and decoded after being received by computing device 202. As used herein, the term “encoding” generally refers to a process of converting data from one format to another format. Similarly, the term “decoding” generally refers to a process of converting data from an encoded format back to an original format. In some embodiments, a content player of computing device 202 can decode media stream 208 as it arrives. In other embodiments, the content player may not have direct access to decode media stream 208 and may, instead, rely on other decoders such as a codec. As used herein, the term “codec” refers to software or hardware for compressing data and decompressing data after receiving it.

Returning to FIG. 1, at step 120, one or more of the systems described herein extracts, by the computing device, a segment of the media stream and metadata for the segment of the media stream from a streaming buffer. For example, an extraction module 214, as part of computing device 202 in FIG. 2, extracts a segment 220 of media stream 208 and metadata 222 for segment 220 from streaming buffer 210.

The systems described herein may perform step 120 in a variety of ways. As used herein, the term “segment” refers to a limited portion of a media stream, such as a segment limited by a size of a streaming buffer or a segment with a predetermined time limit. In some examples, segment 220 of media stream 208 comprises a predetermined length based on a size of streaming buffer 210. In other examples, segment 220 of media stream 208 comprises a predetermined length based on a fixed amount of time. For example, streaming buffer 210 may attempt to maintain a 5 second buffer for incoming media content, and segment 220 may include the full 5 seconds of data from streaming buffer 210 at any given time. In other examples, streaming buffer may maintain longer or shorter lengths of media stream 208 based on factors such as a status of media stream 208, a type of media content, a status of network 204, and/or any other suitable factors.

In one embodiment, extraction module 214 extracts metadata 222 for segment 220 by determining a compression gain of at least one audio frame of segment 220 and/or by determining a compressed frame size of at least one video frame of segment 220. The term “compression gain,” as used herein, generally refers to an amount that is needed to boost an audio signal after compression to return the audio signal to an original level. The term “compressed frame size,” as used herein, generally refers to a file or memory size of a frame after compression. In this embodiment, extraction module 214 extracts separate audio frames and video frames having corresponding timestamps from segment 220. In this embodiment, extraction module 214 uses compression-related metadata to estimate key properties like audio frame energy or video motion. As used herein, the term “metadata” refers to data that describes or provides additional information about other data, files, or the structure of files.

For audio data, many audio codecs embed Dynamic Range Compression (DRC) gain or compression gain as metadata within each compressed frame. Additionally, most audio codecs use a fixed format frame header such that extracting compression gain or DRC gain from a compressed audio frame header can be done with very low computational complexity by mapping the header data structure. In this example, metadata 222 represents how much the audio signal's dynamic range has been adjusted (i.e., how much the amplitude has been compressed or expanded during encoding). Thus, in this example, compression gain metadata correlates directly to the audio signal's energy, with loud sections (i.e., active speech or music) typically having lower compression gains and quieter sections (i.e., silence or low-energy background noise) having higher compression gains. As used herein, the term “energy” generally refers to a magnitude of an audio signal, wherein greater magnitude correlates with louder sound. In this example, a single compressed audio frame may represent a 32 ms or a 42 ms audio signal, which may contain smaller sub-frames.

In the example of FIG. 3, a set of frames 302(1)-(N) may represent an audio signal of segment 220. In this example, extraction module 214 extracts a set of compression gains 304(1)-(N) that correspond to the audio signal. Specifically, set of compression gains 304(1)-(N) represents relative compression gains for each frame of set of frames 302(1)-(N) represented as an audio waveform. As shown in FIG. 3, more noise (e.g., greater waves) is associated with lower compression gains (e.g., lower or negative relative compression gain values), and quiet periods are associated with higher compression gains. In other words, as stated above, compression gain values are inversely correlated with energy levels of audio signals.

For video data, extraction module 214 uses compressed frame size as a proxy to estimate motion within a frame. In this example, video codecs attempt to ensure fluidity of motion between frames, which results in more bits used for encoding when more motion or complexity is detected between successive frames. In other words, because compression can efficiently represent unchanged pixels between successive frames, more movement or more changes to pixels between frames can require more encoding to fully capture the differences. In contrast, slow-moving or static content requires fewer bits to encode due to fewer differences between pixels. Thus, compressed frame size is also inversely correlated with motion or complexity within a video frame.

Returning to FIG. 1, at step 130, one or more of the systems described herein classifies, by the computing device, a level of activity within frames of the segment by a trained model using the metadata of the segment. For example, a classification module 216, as part of computing device 202 in FIG. 2, classifies a level of activity 226 within frames of segment 220 by a trained model 224 using metadata 222.

The systems described herein may perform step 130 in a variety of ways. As used herein, the term “trained model” generally refers to a prediction model that learns from past training data to make future predictions. In one embodiment, trained model 224 represents a Hidden Markov Model (HMM) trained to classify level of activity 226 within audio frames by characterizing an energy of at least one audio frame of segment 220 using the compression gain. In this embodiment, the HMM is also trained to classify level of activity 226 within video frames by characterizing a motion corresponding to at least one video frame of segment 220 using the compressed frame size. The term “Hidden Markov Model,” as used herein, generally refers to a statistical model for analyzing sequences that may have hidden processes but observable results. For example, the HMM can evaluate sequences of audio frames and video frames using observed compression gains and compressed frame sizes without requiring knowledge of hidden encoding processes and hidden states indicating high or low activity. The HMM can be trained using segments of media content with known markers for silent audio frames and low-motion video frames compared to noisy or active audio frames and high-motion or complex video frames. Additionally, the HMM can be updated and retrained with new media clips over time.

As used herein, the term “level of activity” generally refers to a quantitative or qualitative classification assigned to individual frames of a media segment, whether audio or video, based on the degree of perceptible content or change present in each frame. For audio frames, level of activity 226 is determined by estimating the energy of the audio signal within each frame, typically using metadata such as compression gain. Frames with higher energy are classified as “active,” indicating the presence of speech, music, or other significant audio content, while frames with lower energy are classified as “silent,” indicating periods of quiet or low background noise. For video frames, level of activity 226 is determined by estimating the amount of motion or complexity within each frame, typically using metadata such as compressed frame size. Frames with greater motion (i.e., greater change from the previous frame) or complexity are classified as “high-motion,” while frames with less motion or static content are classified as “low-motion.”

In some embodiments, classification module 216 classifies level of activity 226 within an audio frame of the audio frames of segment 220 by comparing the energy of the audio frame with other audio frames over time and, based on the comparison, classifying the audio frame as active or silent. In these embodiments, energy is generally represented by the compression gain of the audio frame, and the compression gain is compared to compression gains of neighboring audio frames and/or other audio frames within segment 220 for relative energy. Audio frames with comparatively low compressions gains indicate higher likelihood of “active” audio content that needs to be preserved without too much compression, while audio frames with high compression gains indicate highly compressed audio that likely does not have as much unique or crucial audio data. Similarly, in some embodiments, classification module 216 classifies level of activity 226 within a video frame of segment 220 by comparing the motion corresponding to the video frame with other video frames over time and, based on the comparison, classifying the video frame as high-motion or low-motion. Video frames that are determined to highly differ from previous frames likely include more motion, while video frames that are visually similar to previous frames likely include less motion. By considering the temporal sequence of frames, the HMM can smooth out noise in the energy and motion estimates and make more reliable frame classifications.

As shown in FIG. 4, trained model 224 evaluates compression gains 304(1)-(3) associated with frames 302(1)-(3). In this example, comparatively low compression gains 304(1) and 304(3) are contrasted with high compression gain 304(2). Based on the determination that low compression gains are associated with high energy and high compression gains are associated with low energy, trained model 224 can determine frames 302(1) and 302(3) have high energies 402(1) and 402(3) while frame 302(2) has a low energy 402(2). Additionally, trained model 224 then classifies each of frames 302(1)-(3) to create classifications 404(1) and 404(3) indicating active audio frames and a classification 404(2) indicating a silent audio frame. Thus, classifications 404(1)-(3) indicate level of activity 226 for frames 302(1)-(3).

In the above embodiments, trained model 224 is trained to identify natural transitions in audio data between silence and activeness, such as short pauses between words or phrases. In these embodiments, trained model 224 is also trained to identify motions and ignore sudden jumps in compression efficiency. In other embodiments, trained model 224 may represent separate models for audio data and video data. Although illustrated as binary classifications in FIG. 4, audio or video classifications may represent a spectrum or a variety of types of data.

Returning to FIG. 1, at step 140, one or more of the systems described herein performs, by the computing device, an adjustment of at least one frame of the segment based on the classification by the trained model. For example, a performance module 218, as part of computing device 202 in FIG. 2, performs an adjustment 228 of at least one frame of segment 220 based on the classification by trained model 224.

The systems described herein may perform step 140 in a variety of ways. As used herein, the terms “adjustment” and “frame adjustment” generally refer to an adjustment of the timing or placement of a frame within a media stream or a segment of a media stream. In some examples, performance module 218 performs adjustment 228 of a silent frame and/or a low-motion frame. By using trained model 224 to identify periods of silence or low motion where playback speed adjustments can be applied without causing noticeable artifacts, classification module 216 can mark the timestamps of these frames such that performance module 218 can retrieve the markers to perform adjustment 228.

In some examples, performance module 218 performs adjustment 228 by repeating the silent frame or the low-motion frame based on a minimum buffer threshold. In other examples, performance module 218 performs adjustment 228 by skipping the silent frame or the low-motion frame based on a maximum buffer threshold. Because silent frames or low-motion frames can be repeated or skipped without causing noticeable artifacts, performance module 218 can select such frames and timestamps to manipulate while preserving active and high-motion frames that are critical for maintaining intelligibility during viewing. By selecting frames that are less noticeable to a user for adjustment, performance module 218 prioritizes maintaining the timing of active and high-motion frames for a smooth user experience. In these examples, frames are repeated to compensate for buffer underflow, such as when a clock of computing device 202 is faster than source device 206 or the media player is consuming media frames faster than frames are received. By repeating frames, performance module 218 can reduce the playback speed to match a slower clock or slower transmission. Similarly, frames are skipped or dropped to compensate for buffer overflow, such as when the clock of computing device 202 is slower than source device 206 or the media player is consuming media frames slower than they are received. In this example, performance module 218 can increase the playback speed to catch up to a faster clock or faster transmission.

In the example of FIG. 5, a timeline 500(2) represents a normal flow, a timeline 500(1) represents a compensation for buffer underflow, and a timeline 500(3) represents a compensation for buffer overflow. In this example, frame 302(2) is determined to be a silent audio frame or a low-motion video frame, with a timestamp of 502. In the example of buffer underflow, frame 302(2) can be replicated at timestamp 502 without causing noticeable audio or video artifacts. In the example of buffer overflow, frame 302(2) can be removed from timestamp 502 without noticeably affecting audio or video during playback. Alternatively, frame 302(2) may be shifted to a different timestamp, such as a timestamp 504, to adjust for a preferred timing.

In some embodiments, frame intervals can be based on a current Presentation Timestamp (PTS) and a previous PTS, with performance module 218 adjusting frame intervals to match desired playback speed. As used herein, the term “Presentation Timestamp” generally refers to metadata that specifies when a specific frame should be displayed to a user. For example, for the best visual performance, incremental or decremental values of a frame interval can be equal to a multiple of the time interval between two consecutive signals. For example, if a video sync frequency is 60 Hz, then |ΔT′−ΔT| should be equal to 1000/60=16.667 ms or a multiple of this value. In one example, the standard frame interval is ΔT. For the speed up, a new interval ΔT′<ΔT, and a frame PTS=prev_PTS+ΔT′. For the slow down, the new interval ΔT′>ΔT, and the frame PTS=prev_PTS+ΔT′. When a source frame rate is less than a render frame rate, no source frame will be dropped completely or repeated too long, which would otherwise cause a juddering effect. This then becomes the reference frame for following frames within segment 220, and the PTS can be changed to a preferred timestamp.

In some examples, as described above, performance module 218 performs adjustment 228 by adjusting an audio timestamp of segment 220 and/or adjusting a video timestamp of segment 220. In additional examples, performance module 218 performs adjustment 228 by aligning the audio timestamp of segment 220 with the video timestamp of segment 220 within a predetermined threshold. In these examples, performance module 218 ensures synchronicity between audio and video data. For example, audio frames may be compressed at 48 KHz while video frames are compressed at 24 frames per second (fps). In these examples, performance module 218 can align audio frames and video frames within the predetermined threshold and repeat or skip frames to avoid mismatched audio and video during playback that would be noticeable to viewers and to avoid needing to pitch the audio up or down when played faster or lower. In other examples, performance module 218 may simultaneously repeat or skip both audio and video frames during silent periods and low-motion periods for segment 220 to adjust to streaming buffer 210 while also comparing audio and video frames to ensure consistency between audio and video. Additionally, if audio and video frames are synchronized, performance module 218 may repeat or skip frames for overlapping silent and low-motion periods.

In the example of FIG. 6, two different frame rates are aligned by dropping frame 302(2) from the faster frame rate. In the above examples, frame 302(2) of a timeline 600(2) may represent a silent audio frame that may be dropped to match audio to video data. As another example, FIG. 6 may represent a frame rate conversion. In this example, frames may be repeated or skipped to ensure the same number of frames are processed per second of segment 220. In the example of FIG. 6, frame 302(3) may be dropped from timeline 600(2) of a 25 fps stream to align with a streaming standard of 24 fps in a timeline 600(1). In alternate examples, frames may be repeated or skipped during periods of silent or low-activity audio and/or low-motion video in any other suitable method based on the trained model classifications.

As explained above in connection with method 100 in FIG. 1, the disclosed systems and methods, by utilizing compression-based metadata to classify the activity of audio and video frames, can ensure that playback speed adjustments are applied selectively to sections of the audio or video where a user is unlikely to perceive the changes. Specifically, the disclosed systems and methods first train an HMM to identify low-energy audio periods and low-motion video periods. By applying the HMM to livestreaming media content, the systems and methods described herein can more efficiently and accurately identify audio and video frames that can be repeated or skipped without significantly affecting viewer experience. Additionally, the systems and methods described herein can apply playback speed adjustments only to slower-motion scenes to reduce juddering and to quiet frames to avoid pitch changes.

The disclosed systems and methods then adjust for buffer overflow and buffer underflow to ensure clocking jittering and network conditions do not affect the viewing experience of live media. For example, the systems and methods described herein can compensate for buffer underflow by repeating silent or low-motion frames. In addition, the disclosed systems and methods can compensate for buffer overflow by skipping silent or low-motion frames. The disclosed systems and methods may also apply playback adjustments to ensure synchronicity between audio and video data. Furthermore, by dropping or adding frames as needed, the disclosed systems and methods can enable frame rate conversion without noticeable artifacts. Thus, the systems and methods described herein improve over traditional methods of variable-speed media playback by efficiently handling variable playback for both audio and video data using a lightweight process to ensure high-quality output with minimal computational cost.

Content that is created or modified using the methods described herein may be used and/or distributed in a variety of ways and/or by a variety of systems. Such systems may include content distribution ecosystems, as shown in FIGS. 7-9.

FIG. 7 is a block diagram of a content distribution ecosystem 700 that includes a distribution infrastructure 710 in communication with a content player 720. In some embodiments, distribution infrastructure 710 may be configured to encode data and to transfer the encoded data to content player 720 via data packets. Content player 720 may be configured to receive the encoded data via distribution infrastructure 710 and to decode the data for playback to a user. The data provided by distribution infrastructure 710 may include audio, video, text, images, animations, interactive content, haptic data, virtual or augmented reality data, location data, gaming data, or any other type of data that may be provided via streaming.

Distribution infrastructure 710 generally represents any services, hardware, software, or other infrastructure components configured to deliver content to end users. For example, distribution infrastructure 710 may include content aggregation systems, media transcoding and packaging services, network components (e.g., network adapters), and/or a variety of other types of hardware and software. Distribution infrastructure 710 may be implemented as a highly complex distribution system, a single media server or device, or anything in between. In some examples, regardless of size or complexity, distribution infrastructure 710 may include at least one physical processor 712 and at least one memory device 714. One or more modules 716 may be stored or loaded into memory 714 to enable adaptive streaming, as discussed herein.

Content player 720 generally represents any type or form of device or system capable of playing audio and/or video content that has been provided over distribution infrastructure 710. Examples of content player 720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 710, content player 720 may include a physical processor 722, memory 724, and one or more modules 726. Some or all of the adaptive streaming processes described herein may be performed or enabled by modules 726, and in some examples, modules 716 of distribution infrastructure 710 may coordinate with modules 726 of content player 720 to provide adaptive streaming of multimedia content.

In certain embodiments, one or more of modules 716 and/or 726 in FIG. 7 may represent one or more software applications or programs that, when executed by a computing device, may cause the computing device to perform one or more tasks. For example, and as will be described in greater detail below, one or more of modules 716 and 726 may represent modules stored and configured to run on one or more general-purpose computing devices. One or more of modules 716 and 726 in FIG. 7 may also represent all or portions of one or more special-purpose computers configured to perform one or more tasks.

Physical processors 712 and 722 generally represent any type or form of hardware-implemented processing unit capable of interpreting and/or executing computer-readable instructions. In one example, physical processors 712 and 722 may access and/or modify one or more of modules 716 and 726, respectively. Additionally or alternatively, physical processors 712 and 722 may execute one or more of modules 716 and 726 to facilitate adaptive streaming of multimedia content. Examples of physical processors 712 and 722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 714 and 724 generally represent any type or form of volatile or non-volatile storage device or medium capable of storing data and/or computer-readable instructions. In one example, memory 714 and/or 724 may store, load, and/or maintain one or more of modules 716 and 726. Examples of memory 714 and/or 724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 8 is a block diagram of exemplary components of content distribution infrastructure 710 according to certain embodiments. Distribution infrastructure 710 may include storage 810, services 820, and a network 830. Storage 810 generally represents any device, set of devices, and/or systems capable of storing content for delivery to end users. Storage 810 may include a central repository with devices capable of storing terabytes or petabytes of data and/or may include distributed storage systems (e.g., appliances that mirror or cache content at Internet interconnect locations to provide faster access to the mirrored content within certain regions). Storage 810 may also be configured in any other suitable manner.

As shown, storage 810 may store, among other items, content 812, user data 814, and/or log data 816. Content 812 may include television shows, movies, video games, user-generated content, and/or any other suitable type or form of content. User data 814 may include personally identifiable information (PII), payment information, preference settings, language and accessibility settings, and/or any other information associated with a particular user or content player. Log data 816 may include viewing history information, network throughput information, and/or any other metrics associated with a user's connection to or interactions with distribution infrastructure 710.

Services 820 may include personalization services 822, transcoding services 824, and/or packaging services 826. Personalization services 822 may personalize recommendations, content streams, and/or other aspects of a user's experience with distribution infrastructure 710. Encoding services, such as transcoding services 824, may compress media at different bitrates which may enable real-time switching between different encodings. Packaging services 826 may package encoded video before deploying it to a delivery network, such as network 830, for streaming.

Network 830 generally represents any medium or architecture capable of facilitating communication or data transfer. Network 830 may facilitate communication or data transfer via transport protocols using wireless and/or wired connections. Examples of network 830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 830 may include an Internet backbone 832, an internet service provider 834, and/or a local network 836.

FIG. 9 is a block diagram of an exemplary implementation of content player 720 of FIG. 7. Content player 720 generally represents any type or form of computing device capable of reading computer-executable instructions. Content player 720 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 9, in addition to processor 722 and memory 724, content player 720 may include a communication infrastructure 902 and a communication interface 922 coupled to a network connection 924. Content player 720 may also include a graphics interface 926 coupled to a graphics device 928, an audio interface 930 coupled to an audio device 932, an input interface 934 coupled to an input device 936, and a storage interface 938 coupled to a storage device 940.

Communication infrastructure 902 generally represents any type or form of infrastructure capable of facilitating communication between one or more components of a computing device. Examples of communication infrastructure 902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 724 generally represents any type or form of volatile or non-volatile storage device or medium capable of storing data and/or other computer-readable instructions. In some examples, memory 724 may store and/or load an operating system 908 for execution by processor 722. In one example, operating system 908 may include and/or represent software that manages computer hardware and software resources and/or provides common services to computer programs and/or applications on content player 720.

Operating system 908 may perform various system management functions, such as managing hardware components (e.g., graphics interface 926, audio interface 930, input interface 934, and/or storage interface 938). Operating system 908 may also process memory management models for playback application 910. The modules of playback application 910 may include, for example, a content buffer 912, an audio decoder 918, and a video decoder 920.

Playback application 910 may be configured to retrieve digital content via communication interface 922 and play the digital content through graphics interface 926. A video decoder 920 may read units of video data from audio buffer 914 and/or video buffer 916 and may output the units of video data in a sequence of video frames corresponding in duration to the fixed span of playback time. Reading a unit of video data from video buffer 916 may effectively de-queue the unit of video data from video buffer 916. The sequence of video frames may then be rendered by graphics interface 926 and transmitted to graphics device 928 to be displayed to a user.

In situations where the bandwidth of distribution infrastructure 710 is limited and/or variable, playback application 910 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 720 may also include a storage device 940 coupled to communication infrastructure 902 via a storage interface 938. Storage device 940 generally represent any type or form of storage device or medium capable of storing data and/or other computer-readable instructions. For example, storage device 940 may be a magnetic disk drive, a solid-state drive, an optical disk drive, a flash drive, or the like. Storage interface 938 generally represents any type or form of interface or device for transferring data between storage device 940 and other components of content player 720.

Many other devices or subsystems may be included in or connected to content player 720. Conversely, one or more of the components and devices illustrated in FIG. 9 need not be present to practice the embodiments described and/or illustrated herein. The devices and subsystems referenced above may also be interconnected in different ways from that shown in FIG. 9. Content player 720 may also employ any number of software, firmware, and/or hardware configurations.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive a media stream to be transformed, transform the media stream to detect a proxy for a level of activity within the media stream, output a result of the transformation to a Hidden Markov Model, use the result of the transformation to identify low-activity periods, and store the result of the transformation to adjust the media stream at minimally invasive periods. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
detecting, by a computing device, a media stream from a source device to the computing device;
extracting, by the computing device, a segment of the media stream and metadata for the segment of the media stream from a streaming buffer;
classifying, by the computing device, a level of activity within frames of the segment by a trained model using the metadata of the segment; and
performing, by the computing device, an adjustment of at least one frame of the segment based on the classification by the trained model.

2. The method of claim 1, wherein the segment of the media stream comprises a predetermined length based on a size of the streaming buffer.

3. The method of claim 1, wherein extracting the metadata for the segment of the media stream comprises at least one of:
determining a compression gain of at least one audio frame of the segment; or
determining a compressed frame size of at least one video frame of the segment.

4. The method of claim 3, wherein the trained model comprises a Hidden Markov Model (HMM) trained to:
classify the level of activity within audio frames by characterizing an energy of at least one audio frame of the segment using the compression gain; and
classify the level of activity within video frames by characterizing a motion corresponding to at least one video frame of the segment using the compressed frame size.

5. The method of claim 4, wherein classifying the level of activity within an audio frame of the audio frames of the segment comprises:
comparing the energy of the audio frame with other audio frames over time; and
based on the comparison, classifying the audio frame as active or silent.

6. The method of claim 4, wherein classifying the level of activity within a video frame of the segment comprises:
comparing the motion corresponding to the video frame with other video frames over time; and
based on the comparison, classifying the video frame as high-motion or low-motion.

7. The method of claim 6, wherein performing the adjustment comprises performing the adjustment of at least one of:
a silent frame; or
a low-motion frame.

8. The method of claim 7, wherein performing the adjustment comprises at least one of:
repeating the silent frame or the low-motion frame based on a minimum buffer threshold; or
skipping the silent frame or the low-motion frame based on a maximum buffer threshold.

9. The method of claim 1, wherein performing the adjustment comprises at least one of:
adjusting an audio timestamp of the segment;
adjusting a video timestamp of the segment; or
aligning the audio timestamp of the segment with the video timestamp of the segment within a predetermined threshold.

10. A system comprising:
a detection module, stored in memory, that detects, by a computing device, a media stream from a source device to the computing device;
an extraction module, stored in memory, that extracts, by the computing device, a segment of the media stream and metadata for the segment of the media stream from a streaming buffer;
a classification module, stored in memory, that classifies, by the computing device, a level of activity within frames of the segment by a trained model using the metadata of the segment;
a performance module, stored in memory, that performs, by the computing device, an adjustment of at least one frame of the segment based on the classification by the trained model; and
at least one processor that executes the detection module, the extraction module, the classification module, and the performance module.

11. The system of claim 10, wherein the segment of the media stream comprises a predetermined length based on a size of the streaming buffer.

12. The system of claim 10, wherein the extraction module extracts the metadata for the segment of the media stream by at least one of:
determining a compression gain of at least one audio frame of the segment; or
determining a compressed frame size of at least one video frame of the segment.

13. The system of claim 12, wherein the trained model comprises a Hidden Markov Model (HMM) trained to:
classify the level of activity within audio frames by characterizing an energy of at least one audio frame of the segment using the compression gain; and
classify the level of activity within video frames by characterizing a motion corresponding to at least one video frame of the segment using the compressed frame size.

14. The system of claim 13, wherein the classification module classifies the level of activity within an audio frame of the audio frames of the segment by:
comparing the energy of the audio frame with other audio frames over time; and
based on the comparison, classifying the audio frame as active or silent.

15. The system of claim 13, wherein the classification module classifies the level of activity within a video frame of the segment by:
comparing the motion corresponding to the video frame with other video frames over time; and
based on the comparison, classifying the video frame as high-motion or low-motion.

16. The system of claim 15, wherein the performance module performs the adjustment by performing the adjustment of at least one of:
a silent frame; or
a low-motion frame.

17. The system of claim 16, wherein the performance module performs the adjustment by at least one of:
repeating the silent frame or the low-motion frame based on a minimum buffer threshold; or
skipping the silent frame or the low-motion frame based on a maximum buffer threshold.

18. The system of claim 10, wherein the performance module performs the adjustment by at least one of:
adjusting an audio timestamp of the segment;
adjusting a video timestamp of the segment; or
aligning the audio timestamp of the segment with the video timestamp of the segment within a predetermined threshold.

19. A non-transitory computer-readable medium comprising one or more computer-executable instructions that, when executed by at least one processor of a computing device, cause the computing device to:
detect, by the computing device, a media stream from a source device to the computing device;
extract, by the computing device, a segment of the media stream and metadata for the segment of the media stream from a streaming buffer;
classify, by the computing device, a level of activity within frames of the segment by a trained model using the metadata of the segment; and
perform, by the computing device, an adjustment of at least one frame of the segment based on the classification by the trained model.

20. The non-transitory computer-readable medium of claim 19, wherein the one or more computer-executable instructions cause the computing device to extract the metadata for the segment of the media stream by at least one of:
determining a compression gain of at least one audio frame of the segment; or
determining a compressed frame size of at least one video frame of the segment.
